(19) United States
(12) Patent Application Publication
(10) Pub. No.: US 2026/0274426 A1
(43) Pub. Date: Sep. 17, 2026

(54) ELECTRICAL SYSTEM FOR A TURBINE ENGINE

(71) Applicant: SAFRAN, Paris (FR)

(72) Inventors: Anne Marie LIENHARDT, MOISSY-CRAMAYEL (FR); Guillaume François Daniel BIDAN, MOISSY-CRAMAYEL (FR); Florent Jean-Arnaud ROUGIER, MOISSY-CRAMAYEL (FR)

(73) Assignee: SAFRAN, Paris (FR)

(21) Appl. No.: 18/877,646

(22) PCT Filed: Jul. 5, 2023
(86) PCT No.: PCT/FR2023/051029

§ 371 Date: Dec. 20, 2024

(30) Foreign Application Priority Data
Jul. 7, 2022 (FR) FR2206967

(51) Int. Cl. H02M 7/04; B64D 41/00; F02C 7/00; G01R 19/10; G01R 31/40; H02M 1/44

(52) U.S. Cl. CPC H02M 7/04; B64D 41/00; F02C 7/00; G01R 19/10; G01R 31/40; H02M 1/44; B64D 2221/00

(57) ABSTRACT

An electrical system for a gas turbine engine includes a power supply bus, first and second converters, and a monitoring device connected to the first and second converters. The monitoring device receives a monitoring signal representative of a correction associated with a difference between a measurement of a voltage of the bus and a reference, performs a frequency filtering of the monitoring signal to determine low and high frequency components, pilots the first converter to compensate for a change in a voltage of the bus and being implemented from a first part of the low-frequency component and a first part of the high-frequency component, and pilots the second converter to compensate for the change in the voltage of the bus and being implemented from a second part of the low-frequency component and a second part of the high-frequency component.

### FIELD OF THE INVENTION

The present application relates to the field of gas turbine engines, particularly aircraft engines. More specifically, the present application relates to the management of the supply of electrical charges of an engine and/or an aircraft.

### STATE OF THE ART

An aircraft may comprise at least one engine and each of the engine and of the aircraft may comprise electrical charges and/or power supply sources. An electrical system may connect the charges, the sources and the engine together to enable electrical exchanges between these different elements. The charges may be supplied by mechanical collection from the engine, and the engine may be assisted by electrical collection from the sources, whether during start-up or in flight. During the operation of the engine, the supply needs of the charges may change, sometimes abruptly. On the other hand, the mechanical collection from the engine must respect a certain number of constraints to ensure optimization of the operation of the latter. For example, on takeoff, it is preferable to limit the collection from the low-pressure body of the engine, which is extremely loaded to provide the thrust and cannot afford, in this regard, to experience thrust oscillations related to a variable mechanical collection from the electrical system.

### DISCLOSURE OF THE INVENTION

One aim of the invention is to allow an aircraft engine to respond to a variable load of electrical charges.

For this purpose, according to one aspect of the present disclosure, an electrical system for a gas turbine engine is proposed, comprising:

A power supply bus designed to be connected to at least one charge and configured to provide electrical power to the charge in the form of a continuous signal;
a first converter designed to be connected to a first alternating current generator of a gas turbine engine, the first converter being connected to the bus and configured to regulate the bus in voltage from an electrical power provided by the first alternating current generator;
a second converter designed to be connected to a second alternating current generator of the gas turbine engine, the second converter being connected to the bus and configured to regulate the bus in voltage from an electrical power provided by the second alternating current generator; and
a monitoring device connected to the first converter and to the second converter, the monitoring device being configured to:
   receive a monitoring signal representative of a correction associated with a difference between a measurement of a voltage of the bus and a reference, the difference being representative of a change in a voltage of the bus;
   perform a frequency filtering of the monitoring signal so as to determine at least one low-frequency component and at least one high-frequency component;
   pilot the first converter with a view to compensating for the change in the voltage of the bus, the piloting being implemented from a first part of the low-frequency component and a first part of the high-frequency component; and
   pilot the second converter with a view to compensating for the change in the voltage of the bus, the piloting being implemented from a second part of the low-frequency component and a second part of the high-frequency component.

Advantageously, but optionally, the electrical system can comprise the at least one of the following characteristics, taken alone or in any combination:
it further comprises a third converter designed to be connected to a direct current source, the third converter being connected to the bus and configured to regulate the bus in voltage from an electrical power provided by the direct current source, in which the monitoring device is further connected to the third converter and configured to pilot the third converter with a view to compensating for the change in the voltage of the bus, the piloting being implemented from a third part of the low-frequency component and a third part of the high-frequency component;
it further comprises a direct current source connected to the third converter to provide power to the third converter;
each converter comprises a monitoring member configured to pilot the converter, the monitoring device further comprising a central member configured to:
   receive the monitoring signal;
   perform the frequency filtering of the monitoring signal; and
   transmit to each of the monitoring members a control signal for the piloting of the converters, the control signal having been generated from the first part and the second part of the low-frequency component as well as from the first part and the second part of the high-frequency component;
each converter comprises a monitoring member configured to:
   receive the monitoring signal;
   perform the frequency filtering of the monitoring signal; and
   pilot the converter with a view to compensating for the change in the voltage of the bus, the piloting being implemented from part of the low-frequency component and part of the high-frequency component;
it further comprises:
a first alternating current generator connected to the first converter to provide electrical power to the first converter, the first alternating current generator being designed to be connected to a first rotating body of a gas turbine engine to collect mechanical power from the first rotating body; and
a second alternating current generator connected to the second converter to provide electrical power to the second converter, the second alternating current generator being designed to be connected to a second rotating body of a gas turbine engine to collect mechanical power from the second rotating body;
the monitoring device is configured to pilot the converters as a function of a setpoint of distribution of the collection between the rotating bodies; and
the monitoring device is configured to pilot each of the converters as a function of a maximum collection threshold from each of the rotating bodies and/or from the direct current source.

According to another aspect of the present disclosure, a gas turbine engine assembly is proposed, comprising:
a first rotating body;
a second rotating body; and
an electrical system as previously described, wherein the first alternating current generator is connected to the first rotating body to collect power from the first rotating body and the second alternating current generator is connected to the second rotating body to collect power from the second rotating body.

According to another aspect of the present disclosure, a method for monitoring an electrical system as previously described is proposed, the method being implemented by the monitoring device and comprising:
the receipt of a monitoring signal representative of a correction associated with a difference between a measurement of a voltage of the bus and a reference, the difference being representative of a change in a voltage of the bus;
the frequency filtering of the monitoring signal so as to determine at least one low-frequency component and one high-frequency component;
the piloting of the first converter with a view to compensating for the change in the voltage of the bus, the piloting being implemented from a first part of the low-frequency component and a first part of the high-frequency component; and
the piloting of the second converter with a view to compensating for the change in the voltage of the bus, the piloting being implemented from a second part of the low-frequency component and a second part of the high-frequency component.

### DESCRIPTION OF THE FIGURES

Other characteristics, aims and advantages of the invention will emerge from the following description, which is purely illustrative and non-limiting, and which should be read in relation to the appended drawings in which:

FIG. 1 schematically illustrates an aircraft.

FIG. 2 schematically illustrates an engine.

FIG. 3 schematically illustrates an electrical system according to one aspect of the present disclosure.

FIG. 4 is a flowchart illustrating steps of a method for monitoring an electrical system according to the present disclosure.

FIG. 5 illustrates the operation of part of an electrical system according to one aspect of the present disclosure.

FIG. 6 illustrates the operation of another part of an electrical system according to another aspect of the present disclosure.

In all of the figures, similar elements bear identical references.

### DETAILED DESCRIPTION OF THE INVENTION

### Aircraft

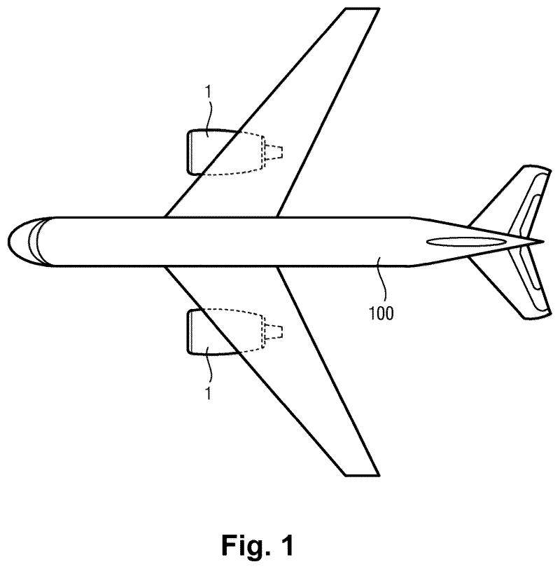

FIG. 1 illustrates an aircraft 100 comprising at least one propulsion unit 1, in this case two propulsion units 1. The aircraft 100 represented is a civil or military airplane, but could be any other type of aircraft 100, such as a helicopter. The propulsion units 1 are added and fixed onto the airplane 100, each under a wing of the airplane 100, as visible in FIG. 1. This is however not limiting, since at least one propulsion unit 1 can also be mounted on the wing of the airplane or at the back of its fuselage.

The aircraft 100 also comprises a plurality of electrical charges (or receivers) (not represented). Each electrical charge is a device supplied by electrical energy and which can be configured to transform the electrical energy that supplies it with another form of energy, such as for example heat or mechanical energy. Non-limiting examples of electrical charges of the aircraft 100 are: an electric motor, a heating and/or air conditioning system, a compressor, etc. These electrical charges make it possible in particular to ensure a certain number of functionalities, in flight as well as on the ground, such as the pressurization and/or the illumination of the cabin of the aircraft 100, the operation of the cockpit, etc.

To supply these electrical charges with electrical energy, the aircraft 100 comprises a plurality of electrical networks, including at least one direct current network. Each electrical network typically comprises a set of electrical conductors, typically a set of wire(s) or bar(s) and/or an assembly of wire(s) and/or one (or more) printed track(s) and/or some equipment used to conduct electricity. The direct current network authorizes the circulation of electrical energy only in the form of a continuous signal.

The electrical energy consumed by the electrical charges can, at least in part, be produced by the engine 2 of the propulsion unit 1, described in more detail below, and more specifically by mechanical collection from LP, HP rotating bodies of the engine 2.

### Propulsion Unit

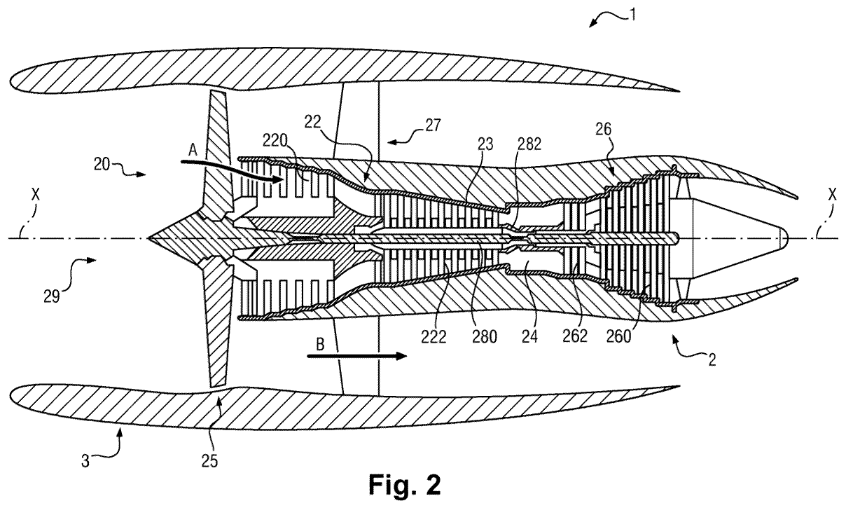

FIG. 2 illustrates a propulsion unit 1 having a longitudinal axis X-X, and comprising an engine 2, which is a gas turbine engine, and a nacelle 3 surrounding the engine 2.

The propulsion unit 1 is intended to be mounted on an aircraft 100, for example in the manner illustrated in FIG. 1. In this regard, the propulsion unit 1 may comprise a mast (not represented) intended to connect the propulsion unit 1 to part of the aircraft 100.

The engine 2 illustrated in FIG. 2 is a twin-spool turbofan engine with direct drive of the fan 20. This is however not limiting since the engine 2 may include a different number of spools and/or streams, and/or be another type of turbojet engine, such as a turbojet engine with driving of the fan via a reducer, or a turboprop. Similarly, what is described is applicable to all types of gas turbine engines that is to say of systems allowing energy transfer between a rotating part and a fluid.

Unless otherwise specified, the terms “upstream” and “downstream” are used with reference to the overall direction of air flow through the propulsion unit 1 in operation. Similarly, an axial direction corresponds to the direction of the longitudinal axis X-X and a radial direction is a direction orthogonal to the longitudinal axis X-X and intersecting the longitudinal axis X-X. Moreover, an axial plane is a plane containing the longitudinal axis X-X and a radial plane is a plane orthogonal to the longitudinal axis X-X. A circumference is understood as a circle belonging to a radial plane and whose center belongs to the longitudinal axis X-X. A tangential or circumferential direction is a direction tangent to a circumference: it is orthogonal to the longitudinal axis X-X but does not pass through the longitudinal axis X-X. Finally, the adjectives “internal” (or “inner”) and “external” (or “outer”) are used with reference to a radial direction so that the internal part of an element is, in a radial direction, closer to the longitudinal axis X-X than the external part of the same element.

As visible in FIG. 2, the engine 2 comprises, from upstream to downstream, a fan 20, a compression section 22 comprising a low-pressure compressor 220 and a high-pressure compressor 222, a combustion chamber 24 and an expansion section 26 comprising a high-pressure turbine 262 and a low-pressure turbine 260. Each of the low-pressure compressor 220, of the high-pressure compressor 222, of the high-pressure turbine 262 and of the low-pressure turbine 260 comprises a rotor part and a stator part, the rotor part being capable of being driven in rotation relative to the stator part about the longitudinal axis X-X. The fan 20, the rotor part of the low-pressure compressor 220, and the rotor part of the low-pressure turbine 260 are connected to each other by a low-pressure shaft 280 extending along the longitudinal axis X-X, thus forming a low-pressure body (LP body) which is a first rotating body. The rotor part of the high-pressure compressor 222 and the rotor part of the high-pressure turbine 262 are connected to each other by a high-pressure shaft 282 also extending along the longitudinal axis X-X, around the low-pressure shaft 280, thus forming a high-pressure body (HP body) which is a second rotating body. As can be seen in FIG. 2, the compression section 22, the combustion chamber 24 and the expansion section 26 are surrounded by an engine case 23, to which the stator parts of the low-pressure compressor 220, of the high-pressure compressor 222, of the high-pressure turbine 262 and of the low-pressure turbine 260 are connected, while the fan 20 is surrounded by a fan case 25. The engine case 23 and the fan case 25 are connected to each other by profiled arms 27 forming straighteners (or OGV for Outlet Guide Vanes) distributed circumferentially all around the longitudinal axis X-X. At least some of these arms 27 may be designed to be structural arms. The longitudinal axis X-X defines the axis of rotation for the fan 20, the rotor parts of the compression section 22 and the rotor parts of the expansion section 26, in other words for the LP body and the HP body, each of which is capable of being driven in rotation about the longitudinal axis X-X relative to the engine case 23 and to the fan case 25.

The nacelle 3 extends radially outside the engine 2, all around the longitudinal axis X-X, so as to surround both the fan case 25 and the engine case 23, and to define, with a downstream part of the engine case 23, a downstream part of a secondary flowpath B, the upstream part of the secondary flowpath B being defined by the fan case 25 and an upstream part of the engine case 23. The upstream part of the nacelle 3 further defines an air inlet 29 through which the fan 20 sucks the air stream circulating through the propulsion unit 1. The nacelle 3 is secured to the fan case 25 and added and fixed onto the aircraft 100 by means of the mast.

The engine 2 may also comprise at least one accessory gearbox (not represented), called AGB, typically housed in a cavity arranged within the nacelle 3. The accessory gearbox comprises a set of gears making it possible to drive in rotation a plurality of shafts around their own axis, accessories being mounted on these shafts to derive useful mechanical power from their rotation. The gear set is itself driven using a power take-off shaft (or RDS for Radial Drive Shaft) connecting, possibly via a transfer case (not represented), the accessory gearbox to the at least one among the high-pressure body 222, 262, 282 and the low-pressure body 20, 220, 260, 280, typically by being meshed with the at least one among the high-pressure shaft 282 and the low-pressure shaft 280. In this regard, the power take-off shaft may extend inside a longitudinal cavity arranged within one of the arms 27. In this way, mechanical power is likely to be collected from the at least one among the high-pressure body 222, 262, 282 and the low-pressure body 20, 220, 260, 280 to be delivered to the at least one of the accessories via the accessory gearbox.

The engine 2 may also comprise a plurality of electrical charges (not represented), such as a starter, variable geometries or de-icing systems, which must also be supplied with electrical energy. The supply of at least some of these electrical charges may be in the form of a continuous signal, typically a continuous voltage.

In operation, the fan 20 sucks an air stream, a portion of which, circulating within a primary flowpath A, is successively compressed within the compression section 22, ignited within the combustion chamber 24 and expanded within the expansion section 26 before being ejected out of the engine 2. The primary flowpath A passes right through the engine case 23. Another portion of the air stream circulates within the secondary flowpath B which takes an elongated annular shape surrounding the engine case 23, the air sucked by the fan 20 being straightened by the straighteners and then ejected out of the propulsion unit 1. In this way, the propulsion unit 1 generates a thrust. This thrust can for example be used for the benefit of the aircraft 100 onto which the propulsion unit 1 is added and fixed.

### Electrical System

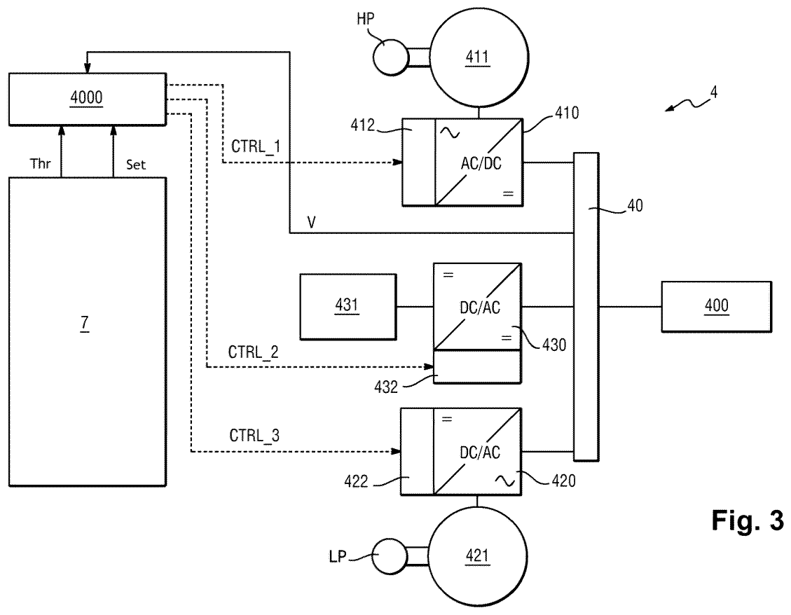

FIG. 3 illustrates an electrical system 4 distributed between the propulsion unit 1 and the aircraft 100 for supplying electrical energy to the electrical charges 400 of the engine 2 and/or of the aircraft 100, typically by means of the direct current network. The electrical system 4 makes it possible in particular to provide the interface between the LP, HP rotating bodies of the engine 2 and the electrical network of the aircraft 100. The electrical system is in particular configured to meet the electrical power needs of the charges 400 of the aircraft 100 and/or of the engine 2 by mechanical collection from the engine 2, and to assist the start-up and/or the in-flight operation of the engine 2 using electrical sources of the aircraft 100 and/or of the engine 2. In other words, the engine 2 is electrically hybridized.

The electrical system 4 comprises an electrical bus 40, or power supply bus 40, connected to at least one electrical charge 400 of the aircraft 100 and/or of the engine 2, preferably a set of several charges 400 of the aircraft 100 and/or of the engine 2, the bus 40 being configured to provide electrical power to the charge 400 in the form of a continuous signal in order in particular to meet its power needs. In other words, the bus 40 is configured to authorize a circulation of electrical energy in the form of a continuous signal. The bus 40 may, for example, comprise a set of electrical conductors, typically a set of wire(s) or bar(s) and/or an assembly of wire(s) and/or one (or more) printed track(s) and/or some equipment used to conduct electricity.

The electrical system 4 further comprises several electrical converters 410, 420, 430, each connected to a respective electrical source 411, 421, 431, that is to say to an element configured to provide electrical power. The electrical sources 411, 421, 431 may be an alternating current generator 411, 421, and/or a direct current source 431. The alternating current generator 411, 421 and the direct current source 431 may belong to the engine 2, that is to say be piloted at the same time as the engine 2, or even be piloted by the engine 2. In this case, they are electrical sources 411, 421, 431 of the engine 2. Besides, the direct current source 431 is not necessarily located in the engine 2 and may for example be housed in a pylon for fixing the engine 2 to the aircraft 100. Alternatively, the direct current source 431 belongs to the aircraft 100, that is to say it is piloted at the same time as the aircraft 100. As can be seen in FIG. 3, the electrical system 4 can thus comprise a first converter 410 connected to a first alternating current generator 411, a second converter 420 connected to a second alternating current generator 421 and, optionally, a third converter 430 connected to a direct current source 431. The third converter 430 and the direct current source 431 are optional in the sense that, in some embodiments, they are absent or, in other embodiments, the direct current source 431 is unavailable. On the other hand, each of the converters 410, 420, 430 is, as visible in FIG. 3, connected to the bus 40. In fact, at least one, if not each, of the converters 410, 420, 430 is configured to regulate the bus 40 in voltage from, that is to say using, an electrical power provided by the electrical source(s) 411, 421, 431 to which the converters 410, 420, 430 are connected. The number and type of converters 410, 420, 430 and electrical sources 411, 421, 431 is, of course, not limiting.

The voltage regulation of the bus 40 is critical. Indeed, the time change in the electrical voltage within the bus 40, during the operation of the electrical system 4, if it can occasionally vary around a given nominal value, must nevertheless remain within the limits of a gauge, which is the guarantee that all of the elements that are connected to the bus 40 operate correctly. The gauge defines, in fact, the upper and lower limits of excursion of the voltage, as a function of time, during the operation of the electrical system 4. The gauge may comprise limits defined for normal and/or abnormal operating conditions, which limits surround, symmetrically or not, a nominal electrical voltage level of the bus 40. In a diagram (not represented) providing the change in the electrical voltage as a function of time, a limit of a gauge is typically represented as a broken or unbroken line. Preferably, even if the limit does not define a constant electrical voltage value initially, in particular during the characteristic time of operating (or starting) the electrical system 4 or during the time of establishing a steady state in the event of a power transient, it is common for the limit to then define a constant electrical voltage value, in order to guarantee the operating stability of the bus 40 and, therefore, of the electrical system 4. Such a gauge may, for example, be defined in a standard relating to the quality of the electrical system 4 and/or of the direct current network, but also be defined by specifications of an aircraft type vehicle to which the electrical system 4 is connected, typically the requirements of the manufacturer of the aircraft 100 and/or of the engine 2 within which the electrical system 4 is integrated.

On the other hand, the voltage regulation of the bus 40 makes it possible to meet the power requirements of the charges 400 connected to the bus 40. Typically, when the amount of power collected by at least one charge 400 from the bus 40 is greater than the amount of power injected onto the bus 40 by at least one converter 410, 420, 430, the voltage of the bus 40 decreases significantly. Conversely, when the amount of power injected by at least one converter 410, 420, 430 onto the bus 40 is greater than the amount of power collected from the bus 40 by at least one charge 400, the voltage of the bus 40 increases. Thus, regulating the voltage of the bus 40 makes it possible, in addition to ensuring the safety of the electrical system 4, to meet the power needs of the charges 400. In other words, each of the converters 410, 420, 430 is configured to permanently adapt the power it injects or collects from the bus 40, according to the voltage of the bus 40, so as to exactly meet the power needs of the charges 400 connected to the bus 40.

This injection or this collection of power from the bus 40 by the converters 410, 420, 430 is in particular permitted by their connection with the electrical sources 411, 421, 431. In fact, at least one, if not each, of the alternating current generators 411, 421 is connected to a LP, HP rotating body of the engine 2 to allow an exchange of mechanical and/or electrical power between the LP, HP rotating body and the alternating current generator 411, 421, preferably to collect a mechanical power from the LP, HP rotating body and transform it into electrical power, which electrical power is then delivered to the first converter 410 and/or to the second converter 420 in order to be injected onto the bus 40. As the electrical power provided by the alternating current generators 411, 421 is in the form of an alternating signal, each of the first converter 410 and of the second converter 420 is configured to transform, in a reversible manner, this alternating signal into a continuous signal adapted to be injected, then circulate, onto the bus 40. Similarly, the direct current source 431 can deliver power in the form of a continuous signal to the third converter 430, which will still convert it, also in a reversible manner, to shape it according to the constraints specific to the bus 40, then inject it onto the bus 40. Each, or at least one, of the alternating current generators 411, 421 can for example be a wound-rotor synchronous machine, typically comprising three stages, called VFG (for Variable Frequency Generator), driven by the at least one among the high-pressure shaft 282 and the low-pressure shaft 280 of the engine 2, typically via the accessory gearbox. Other types of electrical machines can be envisaged, such as, preferably, permanent-magnet synchronous machines, called PMSM (for Permanent-Magnet Synchronous Machine Drives) which have in particular the advantage of having a smaller mass, or such as asynchronous machines (or Induction machine) or variable-reluctance machines. Preferably, the first alternating current generator 411 is connected to the HP body, while the second alternating current generator 421 is connected to the LP body 280. The direct current source 431 may, for its part, comprise a battery, a supercapacitor, a direct current generator and/or a fuel cell. The direct current source 431 makes it possible in particular to relieve the LP, HP rotating bodies, or to take over when, for example, the level of collection required to meet the power needs of the charges 400 is too high, but also makes it possible to absorb some dynamics, such as sudden variations in the behavior of the charges 400.

FIG. 3 also illustrates that the electrical system 4 comprises a monitoring device 412, 422, 432, 4000, connected to at least one, if not each, of the converters 410, 420, 430.

The monitoring device 412, 422, 432, 4000 illustrated in FIG. 3 comprises a central member 4000 and a plurality of monitoring members 412, 422, 432, each of the monitoring members 412, 422, 432 being connected (or integrated) to one of the converters 410, 420, 430. Alternatively, the monitoring device 412, 422, 432 may comprise only the plurality of the monitoring members 412, 422, 432, each of the monitoring members 412, 422, 432 being connected (or integrated) to one of the converters 410, 420, 430.

The monitoring device 412, 422, 432, 4000 is further configured to receive a signal V representative of a measurement of a voltage of the bus 40. To do so, the monitoring device 412, 422, 432, 4000 can be connected to the bus 40 or to a voltage sensor connected to the bus 40, and receive the signal V from the bus 40 (or from this sensor). This signal V can be received via a physical or wireless link. This signal V represents in particular the changing power needs of the charges 400 connected to the bus 40. Typically, when a charge 400 suddenly requires to be able to collect a significant amount of power from the bus 40, due to the response time of the electrical system 4 to provide the bus 40 with the power necessary to compensate for the collected power, the voltage of the bus 40 will suddenly drop, and this drop will be reported to the monitoring device 412, 422, 432, 4000 via the signal V. In the same way, when a charge 400 suddenly offloads a significant amount of power on the bus 40, due to the response time of the electrical system 4 to extract from the bus 40 the power necessary in order to compensate for this offload, the voltage of the bus 40 will suddenly increase, and this increase will be reported to the monitoring device 412, 422, 432, 4000 via the signal V. As a result, the signal V is typically a time signal, that is to say providing (or representing) the change in the voltage of the bus 40 as a function of time. Many charges 400, in particular the charges called “active” charges 400, can have this type of dynamic behavior, which can also vary during the different flight phases.

The changes in the voltage of the bus 40 are compensated by the action of the converters 410, 420, 430, which action therefore follows the voltage change, as abrupt and fluctuating as it can be. This is why this action is coordinated by the monitoring device 412, 422, 432, 4000 to maintain the voltage of the bus 40 within the gauges allowing stable operation of the electrical system 4.

To do so, the monitoring device 412, 422, 432, 4000 is configured to perform a frequency filtering of a monitoring current i, which is representative of the required action of the converters 410, 420, 430 to correct a difference identified between the signal V and a reference V_ref, for example associated with the gauge, as described in more detail below. In reality, the monitoring current i is representative (or associated) with the change in the voltage of the bus 40 identified via the signal V.

However, the high-frequency component of the change in the voltage of the bus 40 requires an immediate and rapid response from the electrical system 4, while its low-frequency component requires a long-term substantive response from the electrical system 4. Typically, during the operation of the engine 2, the power requested by the charges 400 changes with slow dynamics (low-frequency component), but may experience sudden and occasional calls for power (high-frequency component) from some charges 400, for example electric actuators of the flaps of the wings of the aircraft 100. Therefore, it may prove relevant to pilot the converters 410, 420, 430 by discriminating between these different components, by means of the frequency filtering of the monitoring current i.

In general, the low-frequency component of the change in the voltage of the bus 40 will determine the operating point of the engine 2, while the high-frequency component will rather be absorbed by the inertia of the LP, HP rotating bodies. For this, the monitoring device 412, 422, 432, 4000 is further configured to pilot each of the converters 410, 420, 430 with a view to compensating for part of the high-frequency component and part of the low-frequency component. In other words, each converter 410, 420, 430 takes its share of the response to the power needs expressed by the charges 400 and materialized by the change in the voltage of the bus 40. More specifically, each of the converters 410, 420, 430 receives from the monitoring device 412, 422, 432, 4000 a setpoint specific thereto, and from which the converter 410, 420, 430 regulates the voltage of the bus 40. The combination of the voltage regulations of each converter 410, 420, 430 thus allows optimization of the operating point of the engine by permanently following the power needs of the charges 400. Thus, the LP, HP rotating body that would be the most sensitive to rapid fluctuations in the mechanical power collection at some operating points can advantageously be offloaded in favor of the other LP, HP rotating body or of the direct current source 431, in order to allow optimization of the operating point of the engine 2.

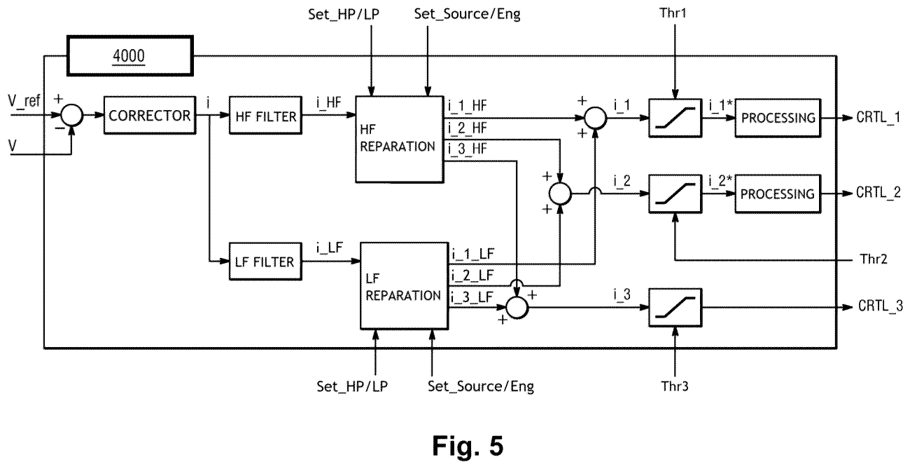

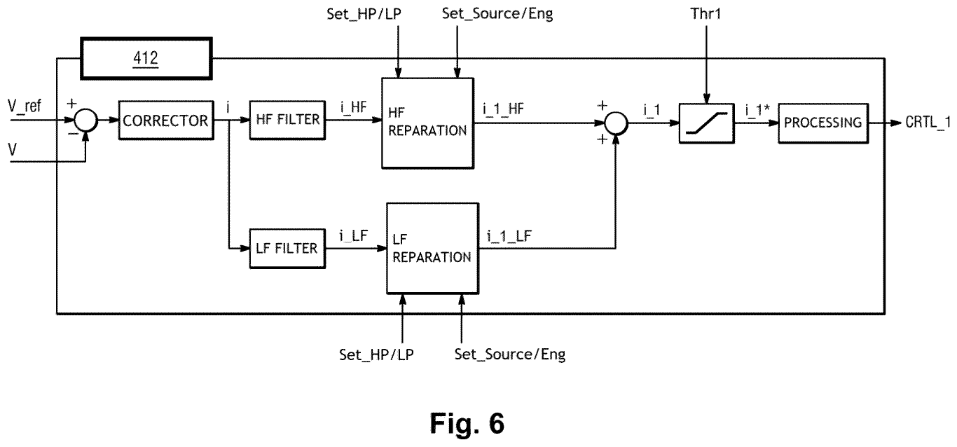

In the electrical system 4 illustrated in FIG. 3, it is the central member 4000 that is configured to receive and then process the signal V, as illustrated in more detail in FIG. 5. Furthermore, the central member 4000 is configured to transmit to each of the monitoring members 412, 422, 432 a control signal CTRL_1, CTRL_2, CTRL_3, which can typically take the form of a control current for the piloting of the converters 410, 420, 430. In the electrical system 4 illustrated in FIG. 3, the monitoring is therefore carried out in a centralized manner. Alternatively, when the monitoring device 412, 422, 432 only comprises the monitoring members 412, 422, 432, each of the monitoring members 412, 422, 432 is configured to receive and process the signal V, then pilot the converter 410, 420, 430 accordingly, as visible in FIG. 6. In other words, the monitoring is then carried out in a decentralized manner.

FIG. 3 further shows the presence of a general controller 7, which may for example be all or part of the system making the interface between the cockpit of the aircraft 100 and the engine 2 (or FADEC or Full Authority Digital Engine Control), typically be the control unit of the engine 2, (or ECU for Electronic Control Unit), which is integrated into the FADEC. The general controller 7 is connected to the monitoring device 412, 422, 432, 4000, in this case to the central member 4000, but could alternatively be directly connected to each of the monitoring members 412, 422, 432 when the central member 4000 is not present. In this case, the functions performed by the central member 4000 are either performed locally in the monitoring members 412, 422, 432, or performed by the general controller 7. The general controller 7 determines additional constraints to be respected by the electrical system 4 to meet the power needs of the charges 400. In particular, the general controller 7 can transmit to the monitoring device 412, 422, 432, 4000 a setpoint Set of the distribution of the collection between the LP, HP rotating bodies and the direct current source 431, and/or a threshold Thr1, Thr2, Thr3 of the maximum collection on at least one, if not each, of the LP, HP rotating bodies and of the direct current source 431, the threshold Thr1, Thr2, Thr3 being, where appropriate, specific to each LP, HP rotating body and to the direct current source 431. More specifically, the distribution setpoint Set indicates to the monitoring device 412, 422, 432, 4000 the manner in which the totality of the power to be collected from the engine 2 to meet the needs of the charges 400 must be distributed between the LP, HP rotating bodies, and the direct current source 431, and can typically take the form of a percentage. The collection thresholds Thr1, Thr2, Thr3 provide, for their part, and for each of the electrical sources 411, 421, 431, the maximum value of the power that the monitoring device 412, 422, 432, 4000 is authorized to collect by their respective converter 410, 420, 430; that is to say a first maximum power value that can be collected from the engine 2 by the first converter 410, via the first alternating current generator 411, a second maximum power value that can be collected from the engine 2 by the second converter 420, via the second alternating current generator 421, and a third maximum power value that can be collected from the direct current source 431 by the third converter 430. The threshold Thr3 associated with the direct current source 431 can typically take the form of a charge or discharge current collection limit if the direct current source 431 is a battery. The monitoring device 412, 422, 432, 4000 is then configured to pilot the converters 410, 420, 430 as a function of this distribution setpoint Set and/or these thresholds Thr1, Thr2, Thr3. More exactly, the parts of the high-frequency component and of the low-frequency component that are compensated by the converter 410, 420, 430 are determined using the distribution setpoint Set and/or the thresholds Thr1, Thr2, Thr3.

The distribution setpoint Set of and/or the collection thresholds Thr1, Thr2, Thr3 transmitted by the general controller 7 may change over time and in particular ensure that each of the LP, HP rotating bodies and the direct current source 431 provide the required power to the charges by optimizing the operating point of the engine 2. For example, during takeoff, which is a flight phase loading high thrust from the fan 20, that is to say a phase during which significant amount of power is transmitted by the LP body to the fan 20, the high-frequency part of the power will be collected preferentially, or even completely, from the HP body, the low-frequency part of the power being collected preferentially, or even completely, from the LP body, in order to avoid thrust oscillations on the LP body. On the contrary, during some flight phases where the operability limits of the HP body are reached, it is preferable to collect more power from the LP body. In any case, this distribution setpoint Set and/or these collection thresholds Thr1, Thr2, Thr3 may also prove necessary to the extent that the mechanical collection has different consequences depending on the LP, HP rotating body on which the power is collected.

### Monitoring Method

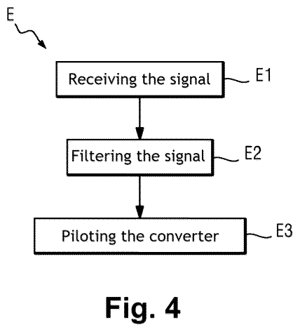

FIG. 4 more specifically illustrates the monitoring method E which can be implemented by the monitoring device 412, 422, 432, 4000 to allow meeting the power needs of the charges 400 in real time, regardless of the operating phase of the engine 2. FIG. 5 illustrates this monitoring method implemented within the central member 4000, while FIG. 6 illustrates this monitoring method implemented within a monitoring member, typically the first monitoring member 412. This monitoring method E allows the electrical system 4 to correct a difference (or error) identified between a reference V_ref, which depends on the voltage gauge of the bus 40 and represents the state in which the bus 40 should be for a normal operation, and a measurement of the voltage V of the bus 40, which represents the reality of the needs of the charges 400 as expressed by injection or collection of power on the bus 40. In other words, this monitoring method E, by correcting this difference between the reference V_ref and the measurement of the voltage V of the bus 40, ensures that the power needs of the charges 400 are satisfied by the power regulation of the bus 40.

More specifically, as visible in FIG. 5 and FIG. 6, a signal V representative of a measurement of the voltage of the bus 40 is received. This signal V can then be compared to a reference V_ref. If there is no difference between reference V_ref and measured signal V, it is because the voltage of bus 40 does not need to be regulated. On the other hand, if a difference is observed, that is to say the voltage of bus 40 has changed, it is necessary for the voltage of the bus 40 to be regulated. To do so, it is necessary to pilot the electrical sources 411, 421, 431 in order to carry out this voltage regulation. This piloting (or this command) can for example consist of the transmission of a setpoint current, a setpoint power or even a setpoint torque. These setpoints will set the way in which the electrical system 4, and more specifically the electrical sources 411, 421, 431, must adapt their operation to successfully carry out this voltage regulation. In this case, a setpoint monitoring current i, easier to manipulate by the monitoring device 412, 422, 432, 4000, whether it is the central member 4000 or the monitoring members 412, 422, 432, can advantageously be generated then processed according to the error identified in the signal V relative to the reference V_ref. The processing can advantageously be implemented by a proportional-integral type corrector. Thus, the monitoring current i is representative of the correction to be made by the electrical system 4 to reduce, or even cancel, the difference between reference V_ref and measured signal V, and thus compensate for the change in the voltage of the bus 40. However, this monitoring current i only sets the general setpoint to be adopted by the electrical system 4, without however discriminating the role that each of the members of the electrical system 4, and more specifically the electrical sources 411, 421, 431, will have to play in the voltage regulation.

In this regard, the monitoring current i, is received E1 by a filtering member which makes it undergo a frequency filtering E2 so as to determine at least one low-frequency component i_LF and one high-frequency component i_HF, which components i_LF, i_HF are, in fact, representative, respectively, of the low-frequency component and of the high-frequency component of the change in the voltage on the bus 40. In fact, the change in the monitoring current i is representative of the change in the voltage of the bus 40, by means of the measured signal V. To do so, the monitoring current i is for example duplicated, then each of the twins of the monitoring current i undergoes a frequency filtering, one low-frequency and the other high-frequency. By high frequency, it should be understood frequencies greater than or equal to 1 Hz and less than or equal to 1,000 Hz, while low frequency refers to frequencies less than 1 Hz.

From a distribution setpoint Set received from the general controller 7, a part dedicated to each converter 410, 420, 430 is determined, for each of the low-frequency component i_LF and of the high-frequency component i_HF. This distribution setpoint Set can be divided into two setpoints: a distribution setpoint Set_HP/LP imposing the distribution of collection between HP body and LP body, and a distribution setpoint Set_Source/Eng between engine 2 and direct current source 431. The distribution setpoint Set_Source/Eng between engine 2 and direct current source 431 can in particular be used to relieve the LP, HP rotating bodies, or take over when, for example, the level of collection required to meet the power needs of the charges 400 is too high, or to allow absorbing some dynamics, such as sudden variations, in the behavior of the charges 400. Furthermore, the distribution setpoint Set_HP/LP imposing the collection distribution between HP body and LP body, and the distribution setpoint Set_Source/Eng between engine 2 and direct current source 431 can each be specific to the low-frequency component and to a high-frequency component of the change in the voltage on the bus 40. Typically, each of the twins of the filtered monitoring current is thus modified i_1_LF, i_2_LF, i_3_LF, i_1_HF, i_2_HF, i_3_HF as a function of the distribution setpoint Set. As visible in FIG. 5, when it is the central body 4000 that is in charge of the monitoring, it results in as many pairs of monitoring current twins i_1_LF/i_1_HF, i_2_LF/i_2_HF, i_3_HF/i_3_LF as there are converters 410, 420, 430 in the electrical system 4. As visible in FIG. 6, when it is each monitoring member 412, 422, 432 that is in charge of the monitoring, it results in only one pair of monitoring current twins i_1_LF/i_1_HF dedicated to the converter 410 to which the monitoring member 412 is connected.

The parts thus determined are combined to be transmitted to the corresponding converter 410, 420, 430 and can, prior to this transmission, undergo a processing based on collection thresholds Thr1, Thr2, Thr3 for each electrical source 411, 421, 431 received from the general controller 7. Typically, each pair of twins i_1_LF/i_1_HF, i_2_LF/i_2_HF, i_3_HF/i_3_LF of the monitoring current is summed i_1, i_2, i_3, then processed using the collection thresholds Thr1, Thr2, Thr3 if necessary, so as to provide a final monitoring current i_1*, i_2*, that can undergo a final processing to correspond to the constraints specific to the converters 410, 420, 430, ready to be routed CTRL_1, CTRL_2, CTRL_3 to the converter 410, 420, 430 to ensure its piloting.

Each converter 410, 420, 430 is piloted E3, for example using the final monitoring current CTRL_1, CTRL_2, CTRL_3, with a view to compensating for its part of the low-frequency component and its part of the high-frequency component of the change in the voltage of the bus 40.

1-10. (canceled)

11. An electrical system for a gas turbine engine, the electrical system comprising:
a power supply bus designed to be connected to at least one charge and configured to provide electrical power to the charge in the form of a continuous signal;
a first converter designed to be connected to a first alternating current generator of a gas turbine engine, the first converter being connected to the bus and configured to regulate the bus in voltage from an electrical power provided by the first alternating current generator;
a second converter designed to be connected to a second alternating current generator of the gas turbine engine, the second converter being connected to the bus and configured to regulate the bus in voltage from an electrical power provided by the second alternating current generator; and
a monitoring device connected to the first converter and to the second converter, the monitoring device being configured to:
receive a monitoring signal representative of a correction associated with a difference between a measurement of a voltage of the bus and a reference, the difference being representative of a change in a voltage of the bus;
perform a frequency filtering of the monitoring signal so as to determine at least one low-frequency component and at least one high-frequency component;
pilot the first converter in order to compensate for the change in the voltage of the bus, the piloting of the first converter being implemented from a first part of the low-frequency component and a first part of the high-frequency component; and
pilot the second converter in order to compensate for the change in the voltage of the bus, the piloting of the second converter being implemented from a second part of the low-frequency component and a second part of the high-frequency component.

12. The electrical system according to claim 11, further comprising a third converter designed to be connected to a direct current source, the third converter being connected to the bus and configured to regulate the bus in voltage from an electrical power provided by the direct current source,
wherein the monitoring device is further connected to the third converter and configured to perform a piloting of the third converter in order to compensate for the change in the voltage of the bus, and
wherein the piloting of the third converter is implemented from a third part of the low-frequency component and a third part of the high-frequency component.

13. The electrical system according to claim 12, further comprising a direct current source connected to the third converter to provide power to the third converter.

14. The electrical system according to claim 11, wherein the first converter and the second converter comprise respectively a first monitoring member and a second monitoring member configured to perform respectively the piloting of the first converter and the second converter,
wherein the monitoring device further comprises a central member configured to:
receive the monitoring signal;
perform the frequency filtering of the monitoring signal; and
transmit to the first monitoring member a first control signal for the piloting of the first converter and to the second monitoring member a second control signal for the piloting of the second converter, the first control signal having been generated from the first part of the low-frequency component and the first part of the high-frequency component, and
wherein the second control signal has been generated from the second part of the low-frequency component and the second part of the high-frequency component.

15. The electrical system according to claim 11, wherein the first converter and the second converter comprise respectively a first monitoring member and a second monitoring member,
the first monitoring member being configured to:
receive the monitoring signal;
perform the frequency filtering of the monitoring signal; and
perform the piloting of the first converter,
the second monitoring member being configured to:
receive the monitoring signal;
perform the frequency filtering of the monitoring signal; and
perform the piloting of the second converter.

16. The electrical system according to claim 11, further comprising:
a first alternating current generator connected to the first converter to provide electrical power to the first converter, the first alternating current generator being designed to be connected to a first rotating body of a gas turbine engine to perform a collection of a mechanical power from the first rotating body; and
a second alternating current generator connected to the second converter to provide electrical power to the second converter, the second alternating current generator being designed to be connected to a second rotating body of a gas turbine engine to perform a collection of a mechanical power from the second rotating body.

17. The electrical system according to claim 16, wherein the monitoring device is configured to pilot the first converter and the second converter as a function of a setpoint of a distribution of a collection between the first rotating body and the second rotating body.

18. The electrical system according to claim 16, wherein the monitoring device is configured to pilot the first converter and the second converter as a function of a maximum collection threshold from the first rotating body and the second rotating body; and/or a maximum collection threshold from the direct current source.

19. A gas turbine engine assembly comprising:
a first rotating body;
a second rotating body; and
the electrical system according to claim 16, wherein the first alternating current generator is connected to the first rotating body to collect power from the first rotating body and the second alternating current generator is connected to the second rotating body to collect power from the second rotating body.

20. A method for monitoring an electrical system according to claim 11, the method being implemented by the monitoring device and comprising:
receiving a monitoring signal representative of a correction associated with a difference between a measurement of a voltage of the bus and a reference, the difference being representative of a change in a voltage of the bus;
frequency filtering the monitoring signal so as to determine at least one low-frequency component and at least one high-frequency component;
piloting, from a first part of the low-frequency component and a first part of the high-frequency component, the first converter in order to compensate for the change in the voltage of the bus; and
piloting, from a second part of the low-frequency component and a second part of the high-frequency component, the second converter in order to compensate for the change in the voltage of the bus.

21. The electrical system according to claim 12, wherein the first converter, the second and the third converter comprise respectively a first monitoring member, a second monitoring member and a third monitoring member configured to pilot respectively the first converter, the second converter and the third converter,
wherein the monitoring device further comprising a central member configured to:
receive the monitoring signal;
perform the frequency filtering of the monitoring signal; and
transmit to the first monitoring member a first control signal for the piloting of the first converter, to the second monitoring member a second control signal for the piloting of the second converter and to the third monitoring member a third control signal for the piloting of the third converter, the first control signal having been generated from the first part of the low-frequency component and the first part of the high-frequency component,
wherein the second control signal has been generated from the second part of the low-frequency component and the second part of the high-frequency component, and
wherein the third control signal has been generated from the third part of the low-frequency component and the third part of the high-frequency component.

22. The electrical system according to claim 12, wherein the first converter, the second converter and the third converter comprise respectively a first monitoring member, a second monitoring member and a third monitoring member,
the first monitoring member being configured to:
receive the monitoring signal;
perform the frequency filtering of the monitoring signal; and
perform the piloting of the first converter,
the second monitoring member being configured to:
receive the monitoring signal;
perform the frequency filtering of the monitoring signal; and
perform the piloting of the second converter,
the third monitoring member being configured to:
receive the monitoring signal;
perform the frequency filtering of the monitoring signal; and
perform the piloting of the third converter.
